(19) United States
(12) Patent Application Publication
(10) Pub. No.: US 2023/0180751 A1
(43) Pub. Date: Jun. 15, 2023

(54) ANTIMICROBIAL FORMULA FOR CHEMISTRIES AND COATINGS

(71) Applicant: Theriax, LLC, Tallahassee, FL (US)

(72) Inventors: Wallace Bruce Salter, Panama City, FL (US); Stephen Robert Ribich, Tallahassee, FL (US)

(73) Assignee: Theriax, LLC, Tallahassee, FL (US)

(21) Appl. No.: 18/081,617

(22) Filed: Dec. 14, 2022

Related U.S. Application Data
(60) Provisional application No. 63/289,742, filed on Dec. 15, 2021.

(51) Int. Cl. A01N 43/50; A01N 59/00; A01P 1/00; A01N 25/02

(52) U.S. Cl. CPC A01N 43/50; A01N 59/00; A01P 1/00; A01N 25/02

(57) ABSTRACT

An in situ generation of a biocide, such as monochlorodimethylhydantoin (“MCDMH”) and/or dichlorodimethylhydantoin (“DCDMH”), suitable as a preservative for paints is provided along with a dried surface coating having a biocidal surface comprising MCDMH and/or DCDMH. Also, the present invention provides for a dried coating have a surface comprising an inert compound, such as dimethylhydantoin (“DMH”), whose biocidal capabilities may be activated by applying a chlorine treatment to the dried surface. Further, this invention provides for liquids that can be used to create the above-described coatings.

### BACKGROUND OF THE INVENTION

This invention is directed towards an additive for canned, aerosol, and other packaged paints, varnishes, stains, and similar products including caulking compounds, liquid putty, adhesives, and similar high moisture or liquid building materials which may have a water based or latex based chemistry.

This invention relates to antimicrobial compounds that are commonly used to increase the shelf life and or impart self-disinfecting properties to many types of coatings and other products. Various Government safety regulators, healthcare providers, and industry associations have issued warnings and directives around the use and or prohibition of several antimicrobial additives in paints, binders, and adhesives. Some of these include compounds in the isothiazolinone family, quaternary alkyl salts, triclosan, zinc pyrithione, and nano-silver, among others.

Consequently, there is a need for new, more market friendly antimicrobial formulations that may be used in novel formulations of antimicrobial paints and binders that may act against bacteria that deposit or grow on surfaces.

### BRIEF SUMMARY OF THE INVENTION

It is one aspect of at least one of the present embodiments to provide for a preservative for paint.

It is one aspect of at least one of the present embodiments to provide for a process of using an antimicrobial agent within packaged paint where the preservative provides for a longer shelf life for the paint.

It is a further aspect of at least one embodiment of this invention to provide for an antimicrobial agent for use in paints, and a process of applying the paint or paints containing an effective amount of the preservative, wherein the preservative imparts to a surface of the dried paint an antimicrobial surface that reduces bacterial counts.

It is a further aspect of at least one embodiment of this invention to provide for an antimicrobial agent within a film forming substrate such that when the substrate is applied to a surface such as a textile and dried, the dried surface has antimicrobial properties that may be activated or reactivated through a surface treatment with a chloride containing product, such as bleach, to provide an antimicrobial surface.

It is a further aspect of at least one embodiment of this invention to provide packaged paint containing an effective amount of an in situ biocide of monochlorodimethylhydantoin (“MCDMH”) ranging from about 0.1 mg/mL to about 30 mg/ml.

It is a further aspect of at least one embodiment of this invention to provide a dried paint surface having an effective amount of a biocide DCDMH or MCDMH that is present on an exposed surface of the dried paint.

It is a further aspect of at least one embodiment of this invention to provide a process of providing an antimicrobial surface comprising the steps of: providing a coating composition comprising an effective amount of a biocide DCDMH or MCDMH, applying the coating composition to a surface, and allowing the coating composition to dry, the resulting coating composition substrate having a surface that is more resistant to bacterial, viral, protozoal, or fungal growth and colonization than a coated surface containing no biocide.

It is a further aspect of at least one embodiment of this invention to provide a packaged water-based product containing a biocide, where such water-based products may include water-based paints, stains, dyes, binders, polymers and latex emulsions, water-based adhesives, cosmetics, paper coatings, machine working fluids, textile finish solutions, car products, laundry additives, mineral slurries and dispersions, and agricultural pesticide products.

It is a further aspect of at least one embodiment of this invention to provide a process of activating a coated biocide surface containing dimethylhydantoin (“DMH”) with a chlorine treatment.

These and other features, aspects, and advantages of the present invention will become better understood with reference to the following description and appended claims.

U.S. Pat. No. 8,552,044, titled “Coatings for Disease Control,” which is incorporated herein by reference, provides useful background on deactivating toxins by surface applied coatings.

### BRIEF DESCRIPTION OF THE DRAWINGS

A fully enabling disclosure of the present invention, including the best mode thereof to one of ordinary skill in the art, is set forth more particularly in the remainder of the specification, including reference to the accompanying drawings.

FIG. 1 sets forth a chemical equation for generation of an antimicrobial agent that is useful as both a preservative in packaged paint as well as imparting a persistent antimicrobial property to the dried paint.

### DETAILED DESCRIPTION OF THE INVENTION

Reference will now be made in detail to some embodiments of the invention, one or more examples of which are set forth below. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used on another embodiment to yield a still further embodiment. Thus, it is intended that the present invention cover such modifications and variations as come within the scope of the appended claims and their equivalents. Other objects, features, and aspects of the present invention are disclosed in the following detailed description. It is to be understood by one of ordinary skill in the art that the present discussion is a description of exemplary embodiments only and is not intended as limiting the broader aspects of the present invention, which broader aspects are embodied in the exemplary constructions.

It is to be understood that the ranges mentioned herein include all ranges located within the prescribed range. As such, all ranges mentioned herein include all sub-ranges included in the mentioned ranges. For instance, a range from 100-200 also includes ranges from 110-150, 170-190, and 153-162. Further, all limits mentioned herein include all other limits included in the mentioned limits. For instance, a limit of up to 7 also includes a limit of up to 5, up to 3, and up to 4.5.

Unless otherwise stated, the terms “about” and “effective amount” means a value of plus or minus 10% of the stated value or range.

In describing the various FIGURES herein, the same reference numbers are used throughout to describe the same material, apparatus, or process pathway. To avoid redundancy, detailed descriptions of much of the apparatus once described in relation to a FIGURE is not repeated in the descriptions of subsequent FIGURES, although such apparatus or process is labeled with the same reference numbers.

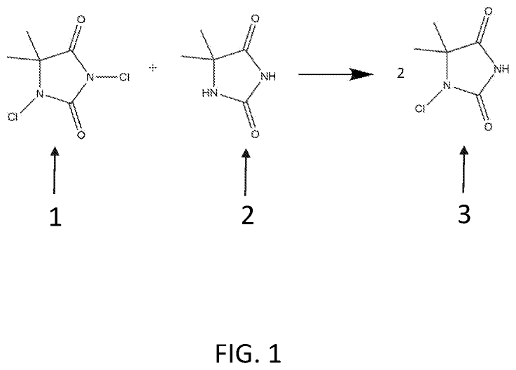

In some embodiments of the present invention, a biocide comprises a preservative chlorinated compound. Referring to FIG. 1, biocidal coatings, such as from paints or polymers, may be formulated using additive concentrations from 1-4 mM of 3 monochlorodimethylhydantoin (“MCDMH”), generated by the in situ reaction of excess 1 dimethylhydantoin (“DMH”) with 2 dichlorodimethylhydantoin (“DCDMH”). The reactants and product in FIG. 1 exist in an equilibrium that is expressed via the following equation:

$$K = \frac{{[ MCDMH ]}^{2}}{[ DMH ] [ DCDMH ]}$$

This reaction is governed by Le Chatelier's Principle. Specifically, the concentrations of DCDMH and MCMDH are in equilibrium, with the balance greatly shifted towards the MCDMH product in excess of 90% theoretical conversion. However, a small amount of DCDMH reactant—which is also a potent biocidal compound—remains in solution. As chlorine is consumed via contact with pathogens, ultraviolet light, or environmental factors, this equilibrium will shift and the ratio or, in other words, DCDMH:MCDMH will change as a result. However, as long as a combination of these two chloramide molecules remains in sufficient concentration, the biocidal efficacy of the product will remain intact.

In some embodiments of the present invention, the biocide capabilities arise from an inert un-chlorinated stabilizer that becomes effective against pathogens after the stabilizer is exposed to a chlorinated compound, such as chlorine bleach. For example, it is also within the scope of the present invention to provide for an effective amount of a paint or similar binder applied surface chemistry that can be activated to establish an antimicrobial or antipathogenic surface. Activation can be by exposure to a liquid hypochlorite or hypochlorous acid solution of an organic non-chlorinated amine, more preferably an amide or imide, and more preferably DMH. An effective amount of an amine, such as DMH, can be within a range of about 0.01 to about 10% weight to a binder such as paint or a loading level that provides a dried surface with a concentration of about 1% by weight of a dried film or paint layer.

In some embodiments, one effective concentration used in aqueous solutions such as paints or alcohol-based solutions has an accurate range for MCDMH/DMH of about 5.0 mg/mL. It is believed that an upper effective limit for the additive ratio is about 25 mg/mL for a ratio of 5 mg/mL, is representative of a 4:1 DMH:MCDMH such that the example used of about 5 mg/mL is from 4 mg/mL DMH and 1 mg/mL of MCDMH which is generated in C2 in situ. Nevertheless, in embodiments of the present invention, the range of MCDMH concentration in general may range from about 0.1 mg/mL to about 30 mg/mL in order to achieve effective biocidal results.

Based upon the mode of action of chlorine and the demonstrated effect as a biocide for bacteria, it is believed that the chlorine-based delivery systems and concentrations are also effective against many pathogens such as mold, viruses, protozoa, fungi, and other micro-organisms that are killed by exposure to free chlorine. Accordingly, it is believed that the ranges and effective amounts set forth herein also provide efficacy in preventing and/or substantially slowing the growth of viruses and molds on treated surfaces.

In coating systems using at least one preservative chlorinated biocide compound or at least one activatable inert un-chlorinated stabilizer, as a general rule, the greater the surface area of the substrate to which the coating is applied, the better performance that would be expected. Accordingly, in more porous substrate would have a greater opportunity for a larger surface mass to be present. Similarly, having some texture to the coating material such as a satin paint as opposed to a flat paint, may also offer a greater surface area exposure of the active surface.

In some embodiments of the present invention, the use of preservative chlorinated biocide compound or an activatable inert un-chlorinated stabilizer can be used with a variety of packaged products including water-based paints, staining dyes, binders, polymers, and latex emulsions, water-based adhesives, cosmetics, paper coatings, building product such as sheetrock, machine working fluids, textile finish solutions, car products, laundry additives, mineral slurries and dispersions, and agricultural pesticide products. When applied as a film forming product, the product can be used with a variety of textiles, fabrics, and a number of other materials where the dried film provides for an activatable surface and/or a pre-established antimicrobial barrier. Suitable film forming applications could include spray-on applications or fluid applied coatings.

In such embodiments of the present invention, the preservative chlorinated compounds may be sold separately in a solution form or as concentrated solid material for mixing as an additive into a coating system. The additives are believed to be compatible with various additives in paint and some additives, such as UV stabilizers, may actually extend the interval of effectiveness for the applied film. Likewise, the additives are compatible with a range of pH including the alkaline pH ranges of water-based acrylic products.

Although preferred embodiments of the invention have been described using specific terms, devices, and methods, such description is for illustrative purposes only. The words used are words of description rather than of limitation. It is to be understood that changes and variations may be made by those of ordinary skill in the art without departing from the spirit or the scope of the present invention. In addition, it should be understood that aspects of the various embodiments may be interchanged, both in whole, or in part. Therefore, the spirit and scope of the invention should not be limited to the description of the preferred versions contained therein.

### Working Examples

The ASTM D2574, Standard Test Method for Resistance of Emulsion Paints in the Container to Attack by Microorganisms, was used to test novel formulations of antimicrobial paints and binders against Pseudomonas aeruginosa (Ps.a.), a biosafety level 2, Gram negative bacteria, commonly associated with respiratory illnesses in hospitals and renowned for its difficulty to kill. The matrices tested were 1) an Ecos™ Paint, interior eggshell white base (Imperial Paints, LLC), a water-based acrylic, which was produced without its customary cocktail of antimicrobial additives; and 2) Revacryl™, an aqueous polymer binder produced by Synthomer PLC, also deficient of its normal antimicrobial additives.

Biocidal test coatings were formulated using a combination of two heterocyclic amides to generate the active compound in situ. Coatings were inoculated with the bacteria, streak tested at periodic intervals, and then analyzed for the presence of bacterial colonies as described below. The test formulations were found to be resistant to Ps.a. through the end of the test period with no visible impact to the coating or polymer integrity.

### Procedure

Tryptic soy agar (“TSA”) was sterilized via programmed autoclave cycle, and plates were poured once the agar had cooled to about 50° C. The plates were then bagged and placed in a refrigerator until they were removed for streak testing. Biocidal coatings (paints or polymer) were formulated using the additive concentrations from 1-4 mM of monochlorodimethylhydantoin (“MCDMH”), generated by the in situ reaction of excess dimethylhydantoin (“DMH”) with dichlorodimethylhydantoin (“DCDMH”). The coatings were mixed with the aqueous additive mixture—adjusted to a pH of 9 using sodium hydroxide—for a minimum of 10 minutes using a shear mixer in sterile polypropylene beakers (400 mL) using 150 mL of paint in each formulation. A 20 mL aliquot of each paint sample was removed from each beaker and placed into a sterile 50 mL polypropylene conical vial. This was repeated twice, making three replicates of each formulation alongside three untreated control replicates.

Coating samples were inoculated at ranges of 1-6×10⁶ CFU/g of Ps. a.—as determined by absorbance measurements—grown in tryptic soy broth (“TSB”). The samples were streaked onto TSA plates using sterile cotton tipped applicators in a Class II, type A2 biosafety cabinet. The plates were streaked at intervals of 1, 2, 3, 5, 7, and 14 days. The samples as well as the streaked plates were placed in an incubator at 35° C. until sampling/analysis. Plates were removed from the incubator after the designated period and closely examined for the presence of microbial contamination. They were evaluated in a binary fashion as either: bacteria were present (+) or not present (−). This standard was adhered to even if the plate appeared to be contaminated by a species other than Ps.a., as was the case in one example below.

### Results

Table 1 shows results for polymer and paint tested against 1.0×10⁶ CFU/g Ps.a. Key: growth (+); no growth (−), n=3. The results in Table 1 reveal that the aqueous polymer binder, Revacryl™, treated with 2 mM MCDMH killed or inhibited the Ps.a. challenge across all samples for the entire test period. The Ecos™ paints treated with 2 mM MCDMH also killed inhibited the Ps.a. challenge; however, there was a single bacterial colony present on one of the three plates after the first day of the test. Although the species could not be precisely identified, it was evident via the lack of green color that it was not a Ps.a. colony, and that this was a contaminant that was introduced during the plating process. Regardless of this, the contamination was not present in any of the plates on subsequent analysis days. Both control types showed Ps.a. growth on 100% of the TSA plates.

Pictures of each streaked plate were taken at the time of analysis. The control plates clearly show the growth of Ps.a., which appears dark green, whereas the treated samples only show the polymer streaks on the agar.

TABLE 1

| Day | 1 | 2 | 3 | 5 | 7 | 14 |
|---|---|---|---|---|---|---|
| Revacryl ™ Control | + + + | + + + | + + + | + + + | + + + | + + + |
| Revacryl ™ + 2 mM | − − − | − − − | − − − | − − − | − − − | − − − |
| MCDMH | | | | | | |
| Ecos ™ Control | + + + | + + + | + + + | + + + | + + + | + + + |
| Ecos ™ + 2 mM | + − − | − − − | − − − | − − − | − − − | − − − |
| MCDMH | | | | | | |

Ps.a. was selected as a test organism because it is pathogenic and notoriously difficult to kill. The results show that the treated formulations kill, or at the very least, inhibit the growth of this bacteria for a period of at least two weeks. Furthermore, the additives did not appear to damage or adversely affect the test materials. The additives were included as aqueous formulations, which facilitates the utility of this technology to systems that are water-based or that wish to maintain low volatile organic compound (VOC) status. The addition of the additives did have the effect of a slight viscosity reduction to the sample but is a property that is easily modifiable within an end product or formulation. Given these data, it is believed that bacteria are unable to grow in paint, binders, adhesives, fillers, and other matrices containing these types of additives at similar concentrations. Additionally, based on the results herein, the biocidal formulations are also believed to be effective against many pathogens such as viruses, protozoa, and fungi.

1. A biocidal product comprising:
a water-based product; and
a preservative chlorinated biocide compound dissolved in the product to a concentration that is effective against pathogens.

2. The biocidal product of claim 1, wherein the compound comprises MCDMH.

3. The biocidal product of claim 2, wherein the concentration of MCDMH ranges from about 0.1 mg/mL to about 30 mg/mL.

4. The biocidal product of claim 1, wherein the compound comprises DCDMH.

5. A biocidal product comprising:
an aqueous polymer binder; and
a preservative chlorinated biocide compound dissolved in the binder to a concentration that is effective against pathogens.

6. The biocidal product of claim 5, wherein the compound comprises MCDMH.

7. The biocidal product of claim 6, wherein the concentration of MCDMH ranges from about 0.1 mg/mL to about 30 mg/mL.

8. The biocidal product of claim 5, wherein the compound comprises DCDMH.

9. A biocidal product comprising:
a water-based product; and
an inert un-chlorinated stabilizer dissolved in the product to a concentration that is effective against pathogens after the stabilizer is exposed to a chlorinated compound.

10. The biocidal product of claim 9, wherein the compound comprises DMH.

11. A biocidal product comprising:
an aqueous polymer binder; and
an inert un-chlorinated stabilizer dissolved in the binder to a concentration that is effective against pathogens after the stabilizer is exposed to a chlorinated compound.

12. The biocidal product of claim 11, wherein the compound comprises DMH.

13. A biocidal coating comprising:
a coating film on a surface; and
a preservative chlorinated biocide compound dissolved in the film to a concentration that is effective against pathogens.

14. The biocidal coating of claim 13, wherein the film is dried paint and the compound is exposed surface of the paint.

15. The biocidal coating of claim 13, wherein the compound comprises MCDMH.

16. The biocidal coating of claim 15, wherein the concentration of MCDMH ranges from about 0.1 mg/mL to about 30 mg/mL.

17. The biocidal coating of claim 13, wherein the compound comprises DCDMH.

18. A biocidal coating comprising:
a coating film on a surface; and
an inert un-chlorinated stabilizer dissolved in the film to a concentration that is effective against pathogens after the stabilizer is exposed to a chlorinated compound.

19. The biocidal coating of claim 18, wherein the film is dried paint and the compound is exposed surface of the paint.

20. The biocidal coating of claim 18, wherein the compound comprises DMH.

21. A process of providing an antimicrobial surface comprising the steps of:
providing a coating composition comprising an effective amount of a biocide MCDMH;
applying the coating composition to a surface; and
allowing the coating composition to dry.

22. The process according to claim 21 further comprising the additional step of applying a liquid chlorine solution to a surface of the dried coating composition.
